(19) United States
(12) Patent Application Publication
(10) Pub. No.: US 2009/0260519 A1
(43) Pub. Date: Oct. 22, 2009

(54) PROCESS FOR THE ABSORPTION OF SULFUR DIOXIDE FROM FLUE GAS

(75) Inventor: Riki Canari, Judean Hills (IL)

Correspondence Address: LUCAS & MERCANTI, LLP, 475 PARK AVENUE SOUTH, 15TH FLOOR, NEW YORK, NY, 10016, US

(73) Assignee: CLUE AS, Bergen (NO)

(21) Appl. No.: 12/439,729

(22) PCT Filed: Sep. 4, 2007
(86) PCT No.: PCT/IL2007/001090

§ 371 Date: Mar. 3, 2009

(30) Foreign Application Priority Data
Sep. 4, 2006 (IL) 177874

(51) Int. Cl. B01D 47/02

(52) U.S. Cl. 95/235

(57) ABSTRACT

The present invention provides a process for the absorption of sulfur dioxide from flue gases comprising the steps of: a) providing input seawater or brackish water; b) treating at least a portion of the seawater or brackish water to form a more concentrated solution of ions; and c) contacting the flue gas with an aqueous stream containing the concentrated solution to form flue gas with a reduced content of sulfur dioxide and a wash solution. wherein the treatment in stage (b) is a process selected from the group consisting of vacuum distillation, distillation, reverse osmosis, or any combination thereof.

The present invention relates to a flue gas desulfurization (FGD) process in which sulfur dioxide is removed from flue gases.

More specifically, the present invention relates to a process for the removal of sulfur dioxide from flue gases utilizing sea water or brackish water.

Fossil fuel combustion is used in industrial processes for many different purposes. Unfortunately, fossil fuel combustion produces several contaminants, which have been found to be detrimental to the environment. In particular, sulfur and nitrogen oxide compounds are the major components of “acid rain”. Sulfur is a naturally occurring element in crude oil, concentrated in the residual components of the crude oil distillation process. The amount of sulfur in the fuel oil depends mainly on the source of crude oil, and to a lesser extent on the refining process. Typically for residual fuel on a world wide basis the value is in the order of 1.5-4%. These values lead to high concentration of SO₂ in flue gases. The concentration of the SO₂ in the emitted gas can reach about 630-1700 ppm.

In recognition of the harm caused by SOx and NOx compounds, different combustion gas cleaning processes have been developed to remove these components of combustion flue gases prior to release of the flue gases into the atmosphere, especially since the burning fossil fuel releases many millions of tons of SO₂ every year.

Ships are fast becoming a major source of air pollution in the EU. Unless more action is taken, they are expected to emit more than all land sources combined by 2020.

European waters will be the first in the world to introduce more stringent sulfur emission regulations for ships, with the coming into force of so-called Sulfur Emission Control Areas (SECAs) in the Baltic Sea in 2006, followed by the North Sea and English Channel in 2007.

Under the European Union (EU) Marine Sulfur Directive, only low-sulfur fuels of less than 1.5% S will be permitted for use. A 1.5% sulfur cap in fuel will apply not only in SECAs, but also on fuels used by passenger vessels operating on regular services to or from any Community port from Aug. 11, 2006.

The EU legislation allows using technologies that abate the sulfur content in the emitted gas as an alternative to using low-sulfur fuels (of 1.5% S). Thus, the technology should assure reductions in sulfur emissions that are at least equal to, or better, than those achieved by lowering the sulfur content in bunker fuel.

A study undertaken for the European Commission by environmental and engineering consultancy Entec UK about the cost, emission reduction potential, and practicality of ship emission abatement technologies, puts the main focus on sea water or brackish water scrubbing.

There are numerous patents that suggest absorbing sulfur from flue gases emitted from ships by using sea water or brackish water, among them are: U.S. Pat. No. 4,085,194; U.S. Pat. No. 4,152,218; U.S. Pat. No. 4,337,230; U.S. Pat. No. 5,690,899; U.S. Pat. No. 6,284,208.

The above inventions utilize the alkalinity of sea water or brackish water which is usually given in terms of concentration of bicarbonate ion, HCO₃⁻) to bind and neutralize the absorbed SO₂ from the flue gas. The main reaction in these processes is the replacing of the bicarbonate ion (HCO₃⁻), with the emitted SO₂ to form the neutralized form of H₂SO₃, i.e., NaHSO₃ or KHSO₃.

None of the above patents utilizes an available source of concentrated sea water or brackish water, i.e., sea water or brackish water having a higher than normal concentration of bicarbonate/carbonate ions, which heretofore has been treated as a waste product and which, according to the present invention, can economically be utilized for treatment of flue gases.

Unfortunately the bicarbonate/carbonate ion concentration in sea water or brackish water is very low. The standard sea water with a chlorine titer of 19 g/kg (salinity of about 3.5%) can have a HCO₃⁻ content of only 0.14 g/kg. Even the water of the Arabian Gulf, which is considered to be body of water having a high bicarbonate content, has a concentration of only about 0.32 g/kg.

As a result, the amount of sea water or brackish water that is required in order to absorb the emitted SO₂ is enormous. For example, when utilizing standard sea water or brackish water with a bicarbonate ion concentration of about 140 ppm, more than 10 Kg of sea-water per each 1 Kg (or about 1 m³) of flue gas is needed, where SO₂ concentration in the emitted gas is about 1000 ppm. Based on this calculation, about 96 m³ of sea water or brackish water per hour is required for a working 1 MW engine.

These huge amounts of sea water or brackish water have to be pumped, contacted with the flue gas and then treated after use. Thus, these processes require large and expansive equipment, and therefore are extremely disadvantageous as they require large areas on deck for placement and operation of this equipment.

Most of the above patents and others which use sea water or brackish water, do not deal with solutions for reducing the amount of sea water or brackish water which is required in order to absorb the emitted SO₂. Few of the patents that deal with this problem (directly or indirectly) add a base to the sea water or brackish water.

The main objective of the present invention is to provide a cost effective method for absorption of SO₂ emitted from flue gases in ships, compared to the methods in which untreated sea water or brackish water is used.

Currently there is a need for methods that are characterized by simplicity and cost effectiveness compared with the suggested methods and those that are presently in use.

The present invention is based inter alia on the realization that there exists a source of concentrated sea water or brackish water, i.e., sea water or brackish water having a higher than normal concentration of bicarbonate/carbonate ions, which is already available in large volumes on seashores and ships, which heretofore has been treated as a waste product and which can economically be utilized for treatment of flue gases.

There are some processes which utilize sea water or brackish water as feed-water and the resulting by-product is water of a high salts concentration, i.e., brine sea water. The most important processes among them are desalination processes and processes in which sea water or brackish water is used as a cooling agent. The by-product or brine stream is usually discharged directly into the ocean.

A number of technologies have been developed for desalination, including reverse osmosis (RO), distillation (including flash distillation), electrodialysis, and vacuum freezing. Two of these technologies, RO and distillation, are commonly used. In RO, feed-water, i.e., sea water or brackish water, is pumped at a high pressure through permeable membranes, thus separating the salts from the water. The feed-water is pretreated to remove particles that would clog the membranes. The quality of the water produced depends on the pressure, the concentration of salts in the feed-water, and the salt permeation constant of the membranes.

In the distillation process, feed-water is heated and then evaporated to separate out dissolved minerals. The most common methods of distillation include multistage flash (MSF), multiple effect distillation (MED), and vapor compression (VC). In MSF, the feed-water is heated and the pressure is lowered, so the water “flashes” into steam. This process constitutes a series of stages, each of which is carried out at a lower pressure than the previous one. In MED, the feed-water passes through a number of evaporators in series. Vapor from one series is subsequently used to evaporate water in the next series. The VC process involves evaporating the feed-water, compressing the vapor, and then using the heated compressed vapor as a heat source to evaporate additional feed-water.

Distillation plants produce a high-quality product, water that ranges from 1.0 to 50 ppm of tds (total dissolved solids), while RO plants produce a water product that ranges from about 10 to 500 ppm tds. The water product recovery relative to input water flow is about 15 to 50% for most seawater or brackish water desalination plants. For every 100 gallons of seawater or brackish water, about 15 to 50 gallons of pure water could be produced, along with brine water containing dissolved solids.

Desalination plants produce liquid wastes that may contain all or some of the following components: high salt concentrations, chemicals used, and toxic metals (which are most likely to be present if the discharge water was in contact with metallic materials used in construction of the plant facilities). Liquid wastes may be discharged directly into the ocean, with or without other discharges (e.g., power plant cooling water or sewage treatment plant effluent). In some cases prior to discharge into the ocean, liquid-wastes are treated or dried out and disposed of in a landfill.

For example, the capacity of the City of Santa Barbara's desalination plant is 7,500 AF/yr (about 7.16 MGD). In May 1992, the plant produced 6.7 MGD of water product and generated 8.2 MGD of waste brine with a salinity of approximately 1.8 times that of seawater or brackish water. An additional 1.7 MGD of brine was generated from filter backwash. Assuming that concentrations of suspended solids in the feed seawater or brackish water range from 10 to 50 ppm, approximately 1.7 to 5.1 cubic yards per day of solids were generated, which is equivalent to one to two truck-loads per week. (Source: Woodward-Clyde Consultants, EIR for the City of Santa Barbara and Ionics, Inc.'s Temporary Emergency Desalination Project, March 1991.)

The present invention is based inter alia on the realization that there exists a source of concentrated sea water or brackish water, i.e., sea water or brackish water having a higher than normal concentration of bicarbonate/carbonate ions, which is readily available in large volumes, for example on seashores and ships, which heretofore has been treated as a waste product and which can economically be utilized for the treatment of flue gases.

More specifically the present invention inter alia is based on the utilization of desalination facilities or facilities of processes in which sea water or brackish water is used as a cooling agent, which already exist in desalination plants and in desalination processes on ships, for producing potable water from sea water or brackish water in that the concentrated sea water or brackish water which is a by-product of desalination is then utilized for contact with flue gas to reduce the content of acidic compounds such as sulfur dioxide therein.

### DETAILED DESCRIPTION OF THE INVENTION

Thus according to the present invention there is now provided a process for the absorption of sulfur dioxide from flue gases comprising the steps of:
a) providing input seawater or brackish water;
b) treating at least a portion of said seawater or brackish water to form a more concentrated solution of ions; and
c) contacting said flue gas with an aqueous stream containing said concentrated solution to form flue gas with a reduced content of sulfur dioxide and a wash solution;
   wherein said treatment in stage (b) is a process selected from the group consisting of vacuum distillation, distillation, reverse osmosis, or any combination thereof.

In preferred embodiments of the present invention said treatment of seawater or brackish water is conducted as a desalination process for producing potable water as described above.

Preferably said treatment step produces 15%-60% w/w potable water of the seawater or brackish water and, brine water which are concentrated by a multiple of 1.17-2.5 compared to the volume of said input seawater or brackish water.

The production of said brine water in step (b) may not be in a large enough capacity to fill the demand of feed water necessary for the desulfurization stage in step (c).

Therefore, in preferred embodiments of the present invention the volume of the solution exiting step (b) is increased by the addition of untreated sea water or brackish water.

Thus, in a preferred embodiment of the present invention the volume of the solution entering step (c) is higher than that exited from step (b), since only a portion of said seawater or brackish water is treated in step (b) to form said more concentrated solution. The addition of the untreated sea water or brackish water increases the total base entering the desulfurization stage.

In preferred embodiments of the present invention an alkaline component is added to said concentrated solution of step (b), in order to increase the basicity of said concentrated solution.

Preferably said alkaline component is selected from the group consisting of lime, limestone, CaO, NaOH, NaHCO₃, lime added to seawater or brackish water, limestone added to seawater or brackish water, CaO added to seawater or brackish water, NaOH added to seawater or brackish water, NaHCO₃ added to seawater or brackish water or a combination thereof.

In said preferred embodiments, said alkaline component is preferably introduced to said concentrated solution in a form selected from the group

In preferred embodiments of the present invention said contact in step (c) of said concentrated solution with flue gas is conducted in any used scrubber in particular in cyclone unit which (produces excellent contact between the two phases). Preferably using cyclone unit contains swirling means as described in EP 0971787B1.

In preferred embodiments of the present invention said flue gas is contacted with oxygen

Preferably said process is conducted in a location selected from the group consisting of ships, seashores, ports, or any region where seawater or brackish water is available.

In especially preferred embodiments of the present invention said process is conducted on a ship.

Thus in yet another preferred embodiment of the present invention seawater or brackish water is added to said wash solution.

The purpose of this addition is to increase the pH level of the wash solution, i.e., neutralize the free acid content, and thus, soluble H₂SO₃ cannot convert back to SO₂ and evaporate back into the environment.

In other preferred embodiments of the present invention said wash solution is contacted with an amount of oxygen.

Preferably said wash solution is decarbonized, thereby forming carbonic acid which is then released as carbon dioxide gas.

In yet another preferred embodiment of the present invention said process comprises the further step of separating undesired components selected from the group consisting of soot, oil, poisons metals and combination thereof from said wash solution

Preferably the present invention comprises further steps for controlling parameters which characterize said wash solution so that said wash solution will have parameters acceptable for discharge of said solution into the sea.

Said parameters are preferably selected from the group consisting of pH, content of unstable sulfites, temperature, soot content, content of toxic metals, and oil content.

While the invention will now be described in connection with certain preferred embodiments in the following examples and with reference to the accompanying figures so that aspects thereof may be more fully understood and appreciated, it is not intended to limit the invention to these particular embodiments. On the contrary, it is intended to cover all alternatives, modifications and equivalents as may be included within the scope of the invention as defined by the appended Claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

In the drawings:

FIGS. 1-4 present flow diagrams of embodiments of the present invention.

### DESCRIPTION OF THE FIGURES

FIG. 1 presents a process wherein in the first stage, sea water or brackish water (1) enters the desalination process step (b) as feed water. This stage produces about 15%-60% w/w potable water of the seawater or brackish water and, brine water which is concentrated by a multiple of 1.17-2.5 compared to the seawater or brackish water.

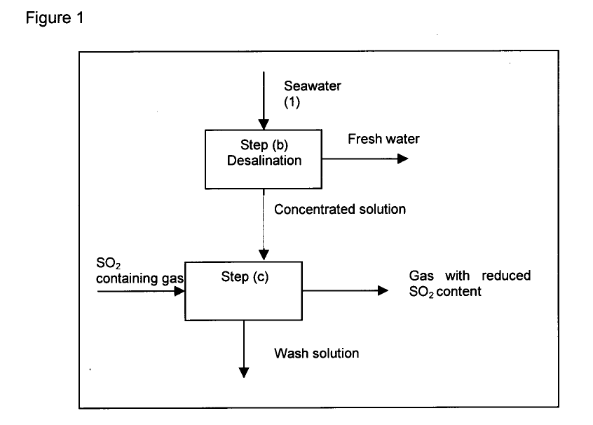

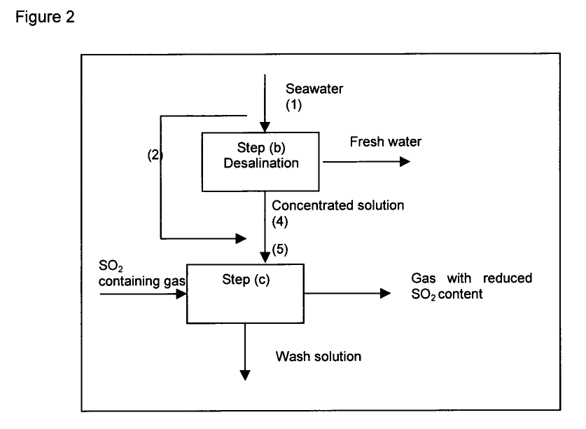

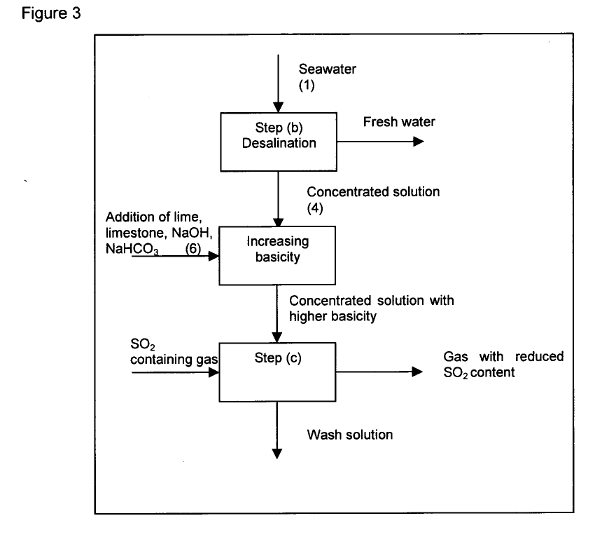

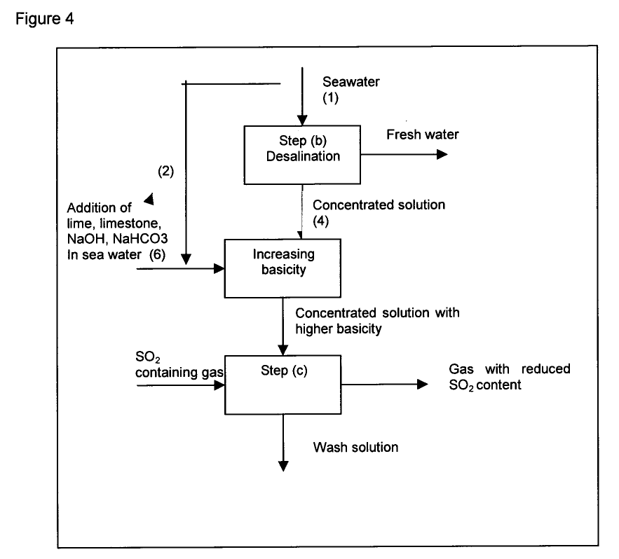

Alternatively, although not represented in FIG. 1, the sea water or brackish water could be used as a cooling agent, and is such a process some of the water would be evaporated, and concentrated seawater or brackish water would be left behind.

The brine water, which heretofore has been treated as a waste product, is economically utilized in the step (c) for treating flue gases. In this step the brine water is contacted with the flue gas by using any kind of scrubber, preferably using a cyclone unit, or more preferably using equipment presented in EP 0971781B1, to form a gas with reduced SO₂ content and a wash solution.

For example without using the present combination of the two processes, in the case of operating an engine at 1 MW, using a fuel with a 2.3% S content, and using sea water or brackish water containing about 140 ppm bicarbonate, about 2.8 kq of sea water or brackish water is needed in order to treat each 1 m³ of the emitted flow gas in order to achieve a removal rate of 40% S. In other words 2.8 kg sea water or brackish water is needed for each 1 m³ of emitted flow gas in order to produce emitted flow gas that contains sulfur in the same concentration as with using a fuel containing 1.5% S. Thus, since the flow of the emitted gas in this case is about 9.6 tons of gas per hour, 27 tons of wash water per hour needs to be treated after the absorption. Separately, in the same site brine water which is produced at a rate of 11 tons per hour from the desalination process should also be treated as waste water. Thus, in this case 38 tons of used water per hour should be treated as waste water, said 38 tons comprising 27 tons/h from the flue gas treatment and 11 tons/h brine water from the desalination process.

Alternatively by using an operation such as that suggested in the present invention, the same efficiency of 40% sulfur reduction in the flue gas can be achieved by using only 11 ton/h of brine water from the desalination process, wherein this brine water has been concentrated by a multiple of about 2.5 compared to the concentration of the initial sea water or brackish water. As a result, the total used water which has to be treated per hour is only 11 tons/hour compared to the 38 tons/hour in the previous case.

Moreover, the total amount of pumped sea water or brackish water necessary to operate these two processes combined is only about 27.5 ton/h compared to about 54.5 tons/hour (about 27 tons/h for the flue gas treatment and 27.5 for the desalination process) where the two processes are not combined.

FIG. 2 presents a process similar to that presented in FIG. 1 with the addition of a stream (2) of untreated sea-water which bypasses the desalination stage and is added to the brine water, stream (4), that is discharging from the desalination stage. This is an example of a case in which the required flow of the feed-water (5) for the flue gas treatment is higher than that formed in the desalination stage. In this case more sea water or brackish water is added to the step (c) in order to achieve the required sulfur absorption capacity.

FIG. 3 presents a process similar to that presented in FIG. 1 except for the fact that a basic alkaline compound (6) is added to the brine water (4) exiting the desalination step for increasing the SO₂ absorption capacity of the step (c). In preferred embodiments said basic compound is selected from the group consisting of lime, limestone, CaO, NaOH, NaHCO₃, lime added to seawater or brackish water, limestone added to seawater or brackish water, NaOH added to seawater or brackish water, NaHCO₃ added to seawater or brackish water or any combination thereof to increase the basicity of the concentrated brine solution (4) exiting desalination step (b). Said basic component is introduced to the system in the form selected from the group consisting of particles, solution, suspension or any combination thereof.

FIG. 4 presents a process similar to that presented in FIG. 3 except that a stream of untreated sea-water (2) is added to the brine water stream (4) that is being discharged from the desalination step (b) after the addition of the alkaline compound (6). (Another option is that stream (2) is added to the brine water stream (4) before the addition of the alkaline compound (6)).

The wash solution formed by the suggested processes described above can be post treatment. The post treatment stages include at least one of the processes selected from the group consisting of:
(a) contacting said wash solution with an oxygen containing gas sufficient for transforming the sulfite ions in said wash solution into sulfate ions;
(b) decarbonizing said wash solution in which the formed carbonic acid is released as carbon dioxide gas;
(c) separating undesired components from said wash solution selected from the group consisting of soot, oil, poisons metals and combination thereof; and
(d) controlling parameters which characterize said wash solution so that said wash solution will have parameters acceptable for discharge of said solution into the sea wherein said parameters are selected from the group consisting of pH, content of unstable sulfites, temperature, soot content, content of toxic metals, and oil content.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A process for the absorption of sulfur dioxide from flue gases comprising the steps of:
a) providing input seawater or brackish water;
b) treating at least a portion of said seawater or brackish water to form concentrated seawater or brackish water having a higher than normal concentration of bicarbonate/carbonate ions; and
c) contacting said flue gas with an aqueous stream containing said concentrated seawater or brackish water to form flue gas with a reduced content of sulfur dioxide and a wash solution.
wherein said treatment in stage (b) is a process selected from the group consisting of vacuum distillation, distillation, reverse osmosis, or any combination thereof.

2. A process according to claim 1 wherein said treatment of seawater or brackish water is conducted as a desalination process for producing potable water.

3. A process according to claim 1 wherein said treatment step produces 15%-60% w/w potable water of the seawater or brackish water and, brine water which are concentrated by a multiple of 1.17-2.5 compared to the volume of said input seawater or brackish water.

4. A process according to claim 1 wherein an alkaline component is added to said aqueous stream, which alkaline component is selected from the group consisting of lime, limestone, CaO, NAOH, NaHCO₃, lime added to seawater or brackish water, limestone added to seawater or brackish water, CaO added to seawater or brackish water, NaOH added to seawater or brackish water, NaHCO₃ added to seawater or brackish water or a combination thereof.

5. A process according to claim 4 wherein said alkaline component is introduced to said aqueous stream in a form selected from the group consisting of particles, solution, suspension or a combination thereof.

6. A process according to claim 1 wherein oxygen is contacted with said flue gas or wash solution.

7. A process according to claim 1 whenever conducted in a location selected from the group consisting of ships, seashores, ports, or any region where seawater or brackish water is available.

8. A process according to claim 7, whenever conducted on a ship.

9. A process according to claim 1 wherein seawater or brackish water is added to said wash solution.

10. A process according to claim 1 wherein said wash solution is decarbonized, thereby forming carbonic acid which is then released as carbon dioxide gas.

11. A process according to claim 1 comprising the further step of separating undesired components selected from the group consisting of soot, oil, poisons metals and combination thereof from said wash solution.

12. A process according to claim 1 comprising further steps for controlling parameters which characterize said wash solution so that said wash solution will have parameters acceptable for discharge of said solution into the sea.

13. A process according to claim 12, wherein said parameters are selected from the group consisting of pH, content of unstable sulfites, temperature, soot content, content of toxic metals, and oil content.

14. A process according to claim 1, wherein the volume of the solution exiting step b is Increased by the addition of untreated seawater or brackish water.

15. A process according to claim 1 wherein only a portion of said seawater or brackish water is treated in step b to form said more concentrated seawater or brackish water and untreated seawater or brackish water is added to the volume of solution exiting step b and entering step c.
